(19) United States
(12) Patent Application Publication
(10) Pub. No.: US 2024/0038415 A1
(43) Pub. Date: Feb. 1, 2024

(54) UMBILICAL

(71) Applicant: TECHNIP N-POWER, Courbevoie (FR)

(72) Inventors: Jamie FLETCHER-WOODS, New Castle Upon Tyne Tyne and Wear (GB); Alan DEIGHTON, Sunderland Tyne and Wear (GB)

(21) Appl. No.: 18/258,463

(22) PCT Filed: Dec. 17, 2021
(86) PCT No.: PCT/IB2021/000911

§ 371 Date: Jun. 20, 2023

(30) Foreign Application Priority Data
Dec. 21, 2020 (GB) 2020253.7

(51) Int. Cl. H01B 7/14; H01B 7/22; H01B 7/04

(52) U.S. Cl. CPC H01B 7/145; H01B 7/225; H01B 7/045

(57) ABSTRACT

A subsea umbilical comprising a plurality of longitudinal strength members, wherein at least one longitudinal strength member is a steel longitudinal strength member and has a semi-conductive coating. The invention can be used both in static, deepwater applications when substantial loading is to be applied to the umbilical, and in dynamic applications when the umbilical is too light and ballast is needed.

The present invention relates to an umbilical for use in the offshore production of hydrocarbons, and in particular to a power umbilical for use in dynamic applications, deep water applications, or both.

### BACKGROUND TO THE INVENTION

An umbilical consists of a group of one or more types of elongated or longitudinal active umbilical elements, such as electrical cables, optical fibre cables, steel tubes and/or hoses, cabled together for flexibility, over-sheathed and, when applicable, armoured for mechanical strength. Umbilicals are typically used for transmitting power, signals and fluids (for example for fluid injection, hydraulic power, gas release, etc.) to and from a subsea installation.

The umbilical cross-section is generally circular, the elongated elements being wound together either in a helical or in a S/Z pattern. In order to fill the interstitial voids between the various umbilical elements and obtain the desired configuration, filler components may be included within the voids.

ISO 13628-5 “Petroleum and natural gas industries—Design and operation of subsea production systems—Part 5: Subsea umbilicals” published in December 2009 by the International Organization for Standardization/API 17E “Specification for Subsea Umbilicals”, 5^{th} Edition, July 2017, published by the American Petroleum Institute, and IEC60840:2020, 5^{th} Edition, May 2019, published by the International Electrotechnical Commission: all provide standards for the design and manufacture of such umbilicals and power cables.

Subsea umbilicals are installed at increasing water depths, commonly deeper than 2000 m. Such umbilicals have to be able to withstand severe loading conditions during their installation and their service life.

The main load bearing components in charge of withstanding the axial loads due to the weight (tension) and to the movements (bending stresses) of the umbilical are: steels tubes (see for example U.S. Pat. No. 6,472,614, WO93/17176, GB2316990), steel rods (U.S. Pat. No. 6,472,614), composite rods (WO2005/124095, US2007/0251694), steel ropes (GB2326177, WO2005/124095), or tensile armour layers (see FIG. 1 of U.S. Pat. No. 6,472,614).

The other elements, such as the electrical and optical cables, the thermoplastic hoses, the polymeric external sheath and the polymeric filler components, do not contribute significantly to the tensile strength of the umbilical voltage.

The load bearing components of most umbilicals are made of steel, which adds strength to the structure. Generally, the strength members are made of carbon steel.

However, there is a risk of induced voltage build-up in the umbilical structure due to an induced current generated between power cores within the power cable structure or the umbilical and the reinforcing strength members or between the reinforcing strength members and other electrical equipment installed in the power cable/umbilical.

Thus, there is a need to provide protection to the strength member to therefore avoid build-up of induced voltages and to reduce the risk of AC corrosion.

### SUMMARY

According to one aspect of the present invention, there is provided a subsea umbilical comprising a plurality of longitudinal strength members, wherein at least one longitudinal strength member is a steel longitudinal strength member and has a semi-conductive coating.

According to another aspect of the present invention, there are provided a method of manufacturing a subsea umbilical, comprising providing a steel longitudinal strength member and extruding a coating onto the steel longitudinal strength member, the coating being semiconducting.

### DESCRIPTION OF THE DRAWINGS

The invention can be better understood with reference to the following detailed description together with the appended illustrative drawings in which:

FIG. 1 is a cross-sectional view of a first umbilical according to an embodiment of the present invention; and

FIG. 2 is a cross-sectional view of a second umbilical according to an embodiment of the present invention.

### DETAILED DESCRIPTION OF THE DRAWINGS

The present invention relates to an umbilical for use in the offshore production of hydrocarbons, and in particular to a power umbilical for use in dynamic applications, deep water applications, or both.

The subsea umbilical of the present invention comprises a plurality of longitudinal strength members, wherein at least one longitudinal strength member is a steel longitudinal strength member and has a semi-conductive coating.

A subsea umbilical typically includes other members or items including one or more of the group comprising electrical cables, optical fibre cables, tubes and/or hoses; optionally cabled together for flexibility, over-sheathed and, if required, armoured for mechanical strength with one or more armour layers.

The umbilical cross-section is generally circular, the elongated elements being wound together either in a helical or in a S/Z pattern. In order to fill the interstitial voids between the various umbilical elements and obtain the desired configuration, filler components may be included within the voids.

Standards that are or which could possibly exemplify standards for the design and manufacture of umbilicals for subsea cables include:
ISO 13628-5 “Petroleum and natural gas industries—Design and operation of subsea production systems—Part 5: Subsea umbilicals” published in December 2009 by the International Organization for Standardization;
API 17E “Specification for Subsea Umbilicals”, 5^{th} Edition, July 2017, published by the American Petroleum Institute;
IEC60840:2020, 5^{th} Edition, May 2019, published by the International Electrotechnical Commission;
IEC 60502-2 for medium voltage (MV) cables, i.e. voltages from 6 kV to 36 kV;
IEC 60840 for high voltage (HV) cables, i.e. voltages from 36 kV to 170 kV;
and
IEC 63026 which covers submarine power cables in the range 6 kV to 72.5 kV.

All of these references are incorporated by way of reference

Subsea umbilicals are installed at increasing water depths, commonly deeper than 2000 m. Such umbilicals have to be able to withstand severe loading conditions during their installation and their service life.

Umbilicals are typically used for transmitting power, signals and fluids (for example for fluid injection, hydraulic power, gas release, etc.) to and from a subsea installation.

Optionally, the umbilical is a riser.

Optionally, the umbilical is a power riser.

Optionally, the umbilical is a dynamic power cable. Dynamic power cables typically involve voltages in the range of about 36 kV to about 170 kV in order to cover applications requiring higher power, such as gas compression and wind turbines.

The main load bearing components in charge of withstanding the axial loads due to the weight (tension) and to the movements (bending stresses) of subsea umbilicals are: steels tubes (see for example U.S. Pat. No. 6,472,614, WO93/17176, GB2316990), steel rods (U.S. Pat. No. 6,472,614), composite rods (WO2005/124095, US2007/0251694), steel ropes (GB2326177, WO2005/124095).

Thus, optionally, in the umbilical of the present invention, the or each steel longitudinal strength member comprises steel rod, steel wires, steel tubes, steel rope or steel strands.

Optionally, the or each steel longitudinal strength member comprises a helical structure of steel strands.

Optionally, the or each steel longitudinal strength member is formed from carbon steel.

The umbilical of the present invention may further comprise one or more other longitudinal strength members, including known strength members. Some others longitudinal strength members such as carbon nanotube ropes may also be partially conductive relative to steel, and the present invention can be used for such partially conductive longitudinal strength members also.

In one embodiment of the present invention, the umbilical comprises a plurality of longitudinal strength members, and each longitudinal strength member is a steel longitudinal strength member having a semi-conductive coating.

Any suitable semiconducting material may be used as the coating material and the skilled person can determine which coating material will be best for the particular conditions to be faced by the umbilical being designed.

In an embodiment of the present invention, the or each semi-conductive coating is formed from an organic semi-conductive material.

Optionally, the organic semiconducting material comprises one or more of the group comprising: polyethylene, polypropylene or both, doped with a suitable conducting material. Organic materials such as polymers and copolymers of ethylene or propylene are convenient coating materials having excellent engineering properties as coating materials and are susceptible to doping to render them semiconducting.

Optionally, the organic material is doped with a carbon material. Carbon suitable for doping can be in various forms such as carbon black, graphite, carbon fibres or a mixture of any of one or more forms of carbon.

The amount of dopant that is required will depend on various factors, such as the intrinsic properties of the starting material (e.g HDPE, MDPE, LDPE, Polystyrene, Nylon, Polypropylene or a polypropylene copolymer), and the nature of the dopant. The skilled reader is able to modify the intrinsic properties of the starting material to provide a final coating have the desired resistivity.

In one embodiment, the semi-conductive coating is carbon doped polyethylene.

Alternatively or additionally, the coating material may be a polymer or copolymer including intrinsically conducting polymers.

For the present invention, the term semiconducting is used to define a material having a volume resistivity in the range 10⁻⁴ to 10¹⁰ Ωm.

Optionally, the coating material has a volume resistivity in the range 0.01-100 Ωm.

Optionally, the coating material has a resistivity in the range 0.1-2.0 Ωm.

The semi-conductive coating provides a path for any induced current in a longitudinal strength member to be drained along the umbilical to an earth, such as seawater. The umbilical could be earthed at one or both ends in a manner known in the art. Steel longitudinal strength members in an umbilical are already typically earthed.

Optionally, the umbilical further comprises a grounding conductor to provide the semiconducting coating with a grounding path.

A grounding path can be provided in various ways. The support and filler components of the umbilical could provide a radial path to earth via any armouring which is typically provided and earthed at both ends.

Optionally, the umbilical of the present invention does not include armouring or is not armoured, for mechanical strength. Armouring, often in the form of one or more ‘armouring layers’ or ‘armoured layers’, but not limited thereto, can be avoided with the correct selection of longitudinal strength members for the umbilical and its intended use.

The present invention extends to a method of manufacturing a subsea umbilical, comprising providing a steel longitudinal strength member and extruding a coating onto the steel longitudinal strength member, the coating being semiconducting.

Methods of coating longitudinal strength members are known in the art, and not further discussed herein.

The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements from any of the embodiments to describe additional embodiments.

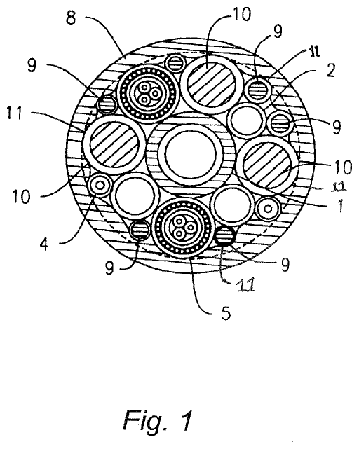

Referring to the drawings, FIG. 1 is a cross-sectional view of a subsea umbilical, for example for use as a riser, according to one embodiment of the invention. This umbilical comprises a central core 1. The central core 1 may be made of steel for transporting fluid. Or, if the core is for transporting electrical power, the core may be made of metallic strands over-sheathed with a thermoplastic material.

Disposed around the core 1 there are
three steel tubes 2 for transporting fluid;
two optical fibre cables 4;
two armoured electric power and/or signalling bundles 5; and
a sheath 8.

The steel tubes 2, optical fibre cables 4 and bundles 5 are stranded together around the central core by means of a vertical helix machine. A suitable vertical helix machine is described in Bryant et al., “Duco, Inc., Umbilical Manufacturing Plant, Current & Future Capabilities,” published in Houston at the Energy Week Conference, 1997. The resulting bundle is then coated.

In order to provide the mechanical strength to the umbilical, with excellent stability, high tensile resistance and fatigue resistance, the umbilical of FIG. 1 has three first longitudinal strength members being solid steel rods 10 which in this embodiment have a diameter of 20 mm. These steel rods are designed to absorb the tensile loading and to ballast the umbilical.

In order further to increase the weight, the umbilical also includes three second longitudinal strength members as small solid steel rods 9, which may be about 8 mm in diameter, in the periphery of the bundle. With this arrangement, the steel rods 9 act as both tension and ballast elements and the need of an outer layer of armouring is avoided.

The use of steel rods 9, 10 in combination with metal tubes 2 increases the tensile capacity of an umbilical, allowing installation and continuous dynamic use in deeper water. The steel rods 9, 10 also increase the mass of the umbilical without increasing the external diameter and consequently the hydrodynamic drag area of the umbilical, which results in reduced dynamic riser excursions, and in turn prevents interference with other objects.

The steel rods 9, 10 may be made of carbon steel or stainless steel, for example. The steel rods are substantially solid. In this context, “substantially solid” means that the steel rods may be completely solid, or may be dense enough to provide enough weight to provide both the tension and ballast for the umbilical design.

Sometimes, there is a risk of induced voltage build-up in the umbilical structure due to an induced current generated between power cores within the power cable structure 5, or the umbilical and the reinforcing strength members, or between the reinforcing strength members and other electrical equipment installed in the power cable/umbilical.

Thus, there is a need to provide protection to the longitudinal steel rods 9, 10 to avoid build-up of any induced voltages, and to reduce the risk of AC corrosion of the steel rods 9, 10 where the said considered protection comprises faults.

To this end, the present invention provides protection around steel rods 9, 10 in a form of a polymer semi-conductive coating 11. The semi-conductive coating 11 can be grounded axially to seawater, and/or via the relevant steel rod 9, 10 which can be tied to earth at one or both ends of the umbilical.

Preferably, the polymer coating 11 is made of a polyolefin polymer material, and is semi-conductive doped with a semiconducting material such as carbon (nano)particles. In this way, the present invention provides a strong and reliable protection to the power umbilical which does not then need to comprise additional armouring layers. The coatings 11 avoid AC corrosion of the steel rods 9, 10 when any AC induced electromagnetic fields arise therein.

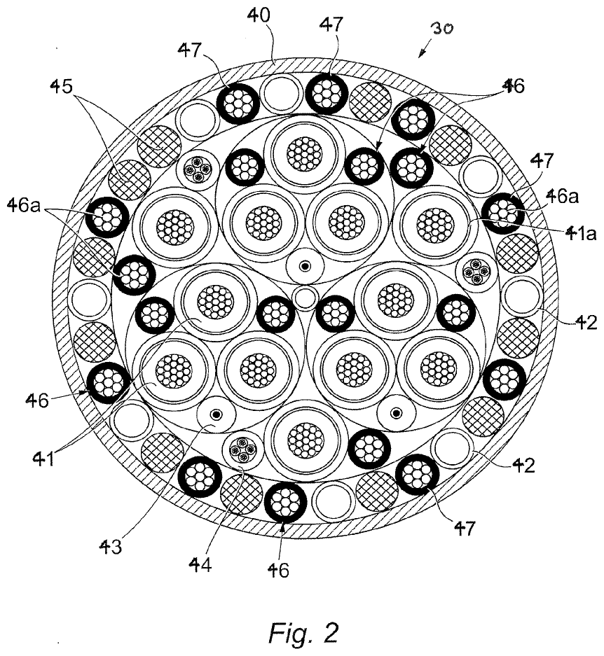

FIG. 2 shows a cross-sectional view of a subsea umbilical 30 according to a second embodiment of the present invention. In the example of a power riser umbilical, the umbilical 30 comprises three large power conductors, each having three electrical power cables 41 therein, which, with three other separated power cables 41a, makes twelve power cables in all. In addition, there are eight tubes 42, three optical fibre cables 43 and three electrical signal cables 44.

The umbilical 30 further includes, both within the power conductors mentioned above, and in the surrounding circumferential sections, a number of longitudinal strength members 46, each comprising seven strands of carbon steel 16a, covered by an extruded semi-conductive coating 47.

The semi-conductive coatings 47 avoid AC corrosion of the strands in the longitudinal strength members 46 when any AC induced electromagnetic fields arise therein due to the power cables 41, 41a.

The strength members 46 extend wholly or substantially the length of the umbilical 30.

In addition, there are a number of polymeric fillers 45 in the umbilical 30 shown in FIG. 2, which again are wholly or substantially constant along the length of the umbilical 30.

Such umbilicals as shown and described herein can still be formed with conventional design and manufacture machinery and techniques, optionally by maintaining a constant outer diameter along the length of the umbilical.

The use of the coatings 47 surrounding and enclosing the steel rods 46a to form longitudinal strength members 46 may also assist, especially during installation of the umbilical, whilst the rods 46a can take axial loads, without being affected by the marine environment. The coating 17 could assist maintaining the cross-sectional shape of the strength members 46 during loading, especially to meet radial stresses, whilst having the mechanical performance to meet high demands on strength, especially in deep water situations, and the environmental requirements including preventing aging, and fatigue resistance, temperature resistance and corrosion resistance.

The present invention can be used both in static, deepwater applications when substantial loading is to be applied to the umbilical, and in dynamic applications when the umbilical is too light and ballast is needed.

Any number of longitudinal strength members can be provided in order to obtain the benefits of the invention, the only limitation being the amount of empty space available given the conduits, steel tubes and other elements needed in the umbilical.

1. A subsea umbilical comprising a plurality of longitudinal strength members, wherein at least one longitudinal strength member is a steel longitudinal strength member and has a semi-conductive coating.

2. An umbilical as claimed in claim 1 wherein the or each steel longitudinal strength member comprises steel rod, steel wires, steel tubes, steel rope or steel strands.

3. An umbilical as claimed in claim 2 wherein the or each steel longitudinal strength member comprises a helical structure of steel strands.

4. An umbilical as claimed in claim 1 wherein the or each steel longitudinal strength member is formed from carbon steel.

5. An umbilical as claimed in claim 1 wherein the or each semi-conductive coating is formed from an organic semi-conductive material.

6. An umbilical as claimed in claim 6, wherein the organic semiconducting material comprises one or more of the group comprising: polyethylene, polypropylene or both; doped with a suitable conducting material.

7. An umbilical as claimed in claim 6, wherein the organic material is doped with a carbon material.

8. An umbilical as claimed in claim 1, wherein the coating material has a resistivity in the range 0.01-100 Ωm.

9. An umbilical as claimed in claim 8, wherein the coating material has a resistivity in the range 0.1-2.0 Ωm.

10. An umbilical as claimed in claim 1 further comprising a grounding conductor to provide the semiconducting coating with a grounding path.

11. An umbilical as claimed in claim 1 wherein the umbilical comprises a plurality of longitudinal strength members, and each longitudinal strength member is a steel longitudinal strength member having a semi-conductive coating.

12. An umbilical as claimed claim 1 not being armoured for mechanical strength.

13. An umbilical as claimed in claim 1 wherein the umbilical is a riser.

14. An umbilical as claimed in claim 13 wherein the riser is a power riser.

15. An umbilical as claimed in claim 1 wherein the umbilical is a dynamic power cable.

16. A method of manufacturing a subsea umbilical, comprising providing a steel longitudinal strength member and extruding a coating onto the steel longitudinal strength member, the coating being semiconducting.
